(19) United States
(12) Patent Application Publication
(10) Pub. No.: US 2022/0358169 A1
(43) Pub. Date: Nov. 10, 2022

(54) ANTI-SPOOFING FOR EMOJI IDENTIFICATIONS

(71) Applicant: Emoji ID, LLC, Oakland, CA (US)

(72) Inventor: Cayle Jon SHARROCK, Johannesburg (SA)

(21) Appl. No.: 17/727,745

(22) Filed: Apr. 23, 2022

Related U.S. Application Data
(60) Provisional application No. 63/179,038, filed on Apr. 23, 2021.

(51) Int. Cl. G06F 16/903

(52) U.S. Cl. CPC G06F 16/90344

(57) ABSTRACT

Implementations generally relate to emojis. In some implementations, a method includes receiving an emoji string, wherein the emoji string comprises a preferred emoji representation. The method further includes mapping the preferred emoji representation to a corresponding canonical emoji representation. The method further includes computing a canonical emoji ID based on the mapping, wherein the canonical emoji ID comprises a canonical emoji string, wherein the canonical emoji string comprises the canonical emoji representation. The method further includes accessing a database using the canonical emoji string.

### CROSS-REFERENCE TO RELATED APPLICATIONS

This application claims the benefit of U.S. Provisional Patent Application Ser. No. 63/179,038, entitled ANTI-SPOOFING FOR EMOJI IDENTIFICATIONS, filed on Apr. 23, 2021, which is hereby incorporated by reference as if set forth in full in this application for all purposes.

### SUMMARY

Implementations generally relate to emojis. In some implementations, a method includes receiving an emoji string, wherein the emoji string comprises a preferred emoji representation. The method further includes mapping the preferred emoji representation to a corresponding canonical emoji representation. The method further includes computing a canonical emoji ID based on the mapping, wherein the canonical emoji ID comprises a canonical emoji string, wherein the canonical emoji string comprises the canonical emoji representation. The method further includes accessing a database using the canonical emoji string.

### BRIEF DESCRIPTION OF THE DRAWINGS

FIG. 1 is a block diagram of an example environment for preventing spoofing of emoji identifications, which may be used for implementations described herein.

FIG. 2 is an example flow diagram for preventing spoofing of emoji identifications, according to some implementations.

FIG. 3 is a block diagram of an example network environment, which may be used for some implementations described herein.

FIG. 4 is a block diagram of an example computer system, which may be used for implementations described herein.

### DETAILED DESCRIPTION

Implementations described herein prevent spoofing of emoji identifications (IDs). Implementations involve emoji IDs that display user-preferred emojis while concealing actual canonical emoji IDs from spoofing.

In some implementations, a system receives an emoji string, where the emoji string comprises a preferred emoji representation. The system then maps the preferred emoji representation to a corresponding canonical emoji representation. The system then computes a canonical emoji ID based on the mapping, where the canonical emoji ID comprises a canonical emoji string, and where the canonical emoji string comprises the canonical emoji representation. The system accesses a database using the canonical emoji string. The terms emoji and emoji representations may be used interchangeably.

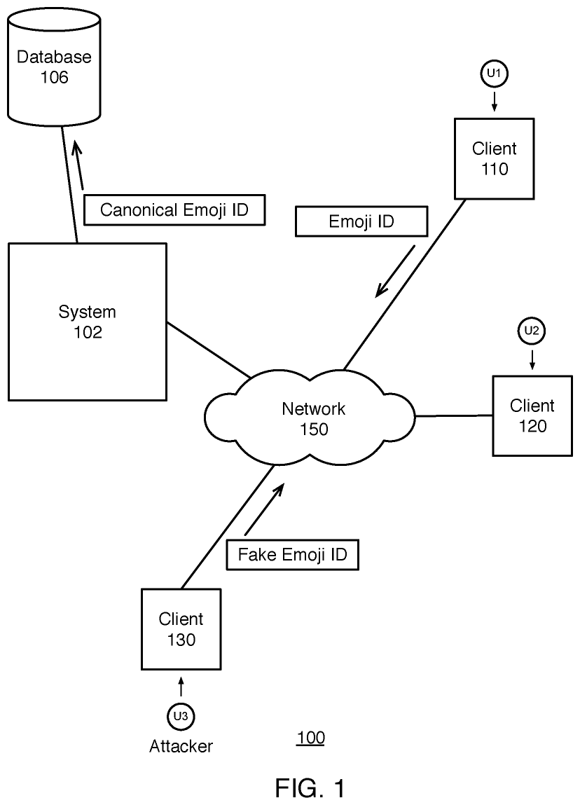

FIG. 1 is a block diagram of an example network environment 100 for preventing spoofing of emoji identifications (IDs), which may be used for some implementations described herein. In some implementations, network environment 100 includes a system 102, which accesses a database 106. Network environment 100 also includes client devices 110, 120, and 130, which may communicate with system 102 and/or may communicate with each other directly or via system 102. Network environment 100 also includes a network 150 through which system 102 and client devices 110, 120, and 130 communicate. Network 150 may be any suitable communication network such as a Wi-Fi network, Bluetooth network, the Internet, etc.

In various implementations, system 102 receives an emoji string that includes a user-preferred emoji representation having a corresponding emoji ID. The terms emoji representation and emoji may be used interchangeably. In various implementations, the emoji ID may correspond to a preferred emoji representation. In various implementations, the emoji ID may represent or be associated with a particular user or entity. In some implementations, if the preferred emoji ID is associated with an entity, any one or more designated users may be authorized to take actions on behalf of the entity.

In various implementations, an emoji ID includes a sequence of emojis. Emojis may be utilized to provide a user with an easy and intuitive way to identify a person (e.g., the user) or an entity. Emojis are miniature pictures that can be used to express thoughts, ideas, and concepts, that can be entered using a keyboard or software application, and can be entered without using alpha-numeric characters. Emojis are often easier to remember for a typical internet user than an alpha-numeric address. As such, a sequence of emojis rather than an alpha-numeric sequence may be better suited to ensuring that a user or customer can successfully access information pertaining to a person or entity associated with a particular emoji ID.

In various implementations, the system displays the user-preferred emoji representation, while concealing an actual canonical emoji ID from spoofing. As described in more detail herein, the preferred emoji representation maps to the corresponding canonical emoji representation. The system determines or computes a canonical emoji ID based on the mapping. The canonical emoji ID is associated with a canonical emoji string that includes the canonical emoji representation. The system accesses the database using the canonical emoji ID.

As described in more detail herein, there may be various different emoji representations that the system associates with the canonical emoji representation. These different emoji representations may visually appear similar to each other, and, thus, could be confused with one another. In various implementations, all of the different emoji representations and corresponding emoji IDs may be associated with and point to a single canonical emoji ID. These emoji representations are also referred to as sibling emoji representations, or sibling emojis. Because sibling emojis look visually similar and could be confused with one another, sibling emojis may be used by an attacker to attempt to spoof the user who owns the canonical emoji ID. This is undesirable.

Generally, an attacker (e.g., at client 130) registers a “fake” emoji ID that looks similar to the real emoji ID. The user may inadvertently click on the “fake” emoji ID thinking that it is not legitimate emoji ID and gets spoofed. In described in more detail herein, spoofing is prevented because the “fake” emoji ID points to or resolves to the same canonical emoji ID string.

In various implementations, the term emoji sequence may be used as an example of a type of ID that can be easy to remember and user-friendly. In some implementations, other sequences of characters that may include a mixture of emoji and non-emoji characters, as well as sequences that do not include emojis can also fall within the scope of the disclosure. As indicated herein, the use of emoji sequences may be a more intuitive and user-friendly way of accessing information pertaining to a particular user or entity without having to remember a myriad of different addresses or identifiers that may rely on less intuitive alpha-numeric sequences. While various implementations are described herein in the context of emoji IDs, implementations may also apply to non-fungible tokens.

For ease of illustration, FIG. 1 shows one block for each of system 102, database 106, and shows three blocks for client devices 110, 120, and 130. Blocks 102 and 106 may represent multiple systems and network databases. Also, there may be any number of client devices. In other implementations, environment 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors or networks including blockchain networks associated with system 102 may facilitate performing the implementations described herein.

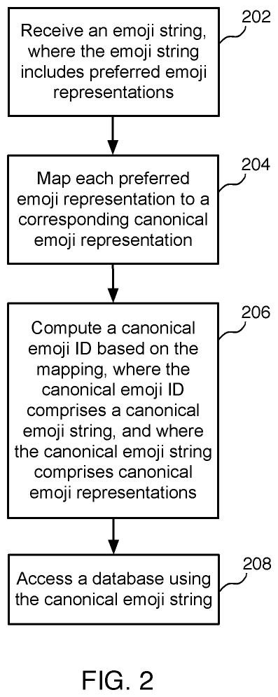

FIG. 2 is an example flow diagram for preventing spoofing of emoji identifications, according to some implementations. In various implementations, a method begins at block 202, where a system such as a server or other computing device receives an emoji string. The emoji string includes one or more preferred emoji representations. As indicated herein, the system displays to the public user-preferred emoji representations, while concealing actual canonical emoji IDs from spoofing. As described in more detail herein, an emoji genus designates a set of variations and sibling emoji representations that may be used when displaying the emoji ID in association with the emoji string.

At block 204, the system maps the preferred emoji representation to a corresponding canonical emoji representation. As described herein, the preferred emoji representation is a user-selected emoji representation from a group of selectable sibling emoji representations of an emoji genus. An emoji genus includes a canonical emoji representation and sibling emoji representations, which are in the emoji genus due to their visual similarity and/or interpretation. Example implementations directed to an emoji genus are described in more detail below.

At block 206, the system computes a canonical emoji ID based on the mapping, where the canonical emoji ID includes a canonical emoji string. In various implementations, the canonical emoji string includes one or more canonical emoji representations.

In various implementations, the canonical emoji ID is associated with an emoji genus (e.g., heart genus). An emoji genus includes a set of emoji representations that are grouped together, because they look visually similar or have similar user interpretations. For example, the heart genus may include a red heart emoji [symbol] , a heart suit emoji [symbol] , a pink heart emoji [symbol] , a brown heart emoji [symbol] , etc. In various implementations, an emoji genus is represented primarily by a single, defined canonical emoji within that emoji genus. For example, a red heart emoji [symbol] may be the canonical emoji for the heart genus.

In various implementations, the emoji genus is associated with the canonical emoji representation and corresponding canonical emoji ID, the preferred emoji representation and corresponding preferred emoji ID, and one or more other sibling emoji representations and corresponding sibling emoji IDs. Sibling emoji representations in the same emoji genus are representations of the canonical emoji representation (e.g., red heart emoji [symbol] ) of the emoji genus. Sibling emoji representation are described in more detail herein.

In various implementations, the canonical emoji ID may be associated with emoji representations. In some implementations, the canonical emoji ID may be associated with text that is a textual representation of a canonical emoji representation.

In various implementations, the canonical emoji ID is associated with an emoji genus, where the emoji genus is associated with a group of sibling emoji representations having one or more shared characteristics. For example, in various implementations, a given emoji genus (e.g., a heart genus) may be associated with a group of emoji representations (e.g., red heart emoji [symbol] , green heart emoji [symbol] , blue heart emoji [symbol] , etc.) having one or more shared characteristics (e.g., a heart shape). The emoji representations in the same emoji genus may also be referred to as sibling emoji representations of that emoji genus. The emoji genus includes the set of sibling emoji representations, and all sibling emoji representations map into or represent the emoji genus and a single canonical emoji representation.

In various implementations, the preferred emoji representation is selectable from a set of sibling emoji representations, where these sibling emoji representations belong to the same emoji genus. As indicated herein, the user may use the preferred emoji representation to represent or function as a proxy for the canonical emoji representation and/or canonical emoji ID. In various implementations, the preferred emoji representation (e.g., green heart emoji [symbol] ) is displayed while corresponding to the emoji genus (e.g., heart genus) and to other associated sibling emoji representations (e.g., blue heart emoji [symbol] , etc.). The relationship between the emoji genus and its associated sibling emoji representations are concealed or hidden from the public, thereby preventing spoofing.

In various implementations, the preferred emoji representation may function as the canonical emoji representation. For example, assume the “heart” genus' canonical emoji representation is a red heart emoji [symbol] , and the genus is made up of the 7 (sibling) emoji representations: a red heart emoji [symbol] , a heart suit emoji [symbol] , a pink heart emoji [symbol] , a brown heart emoji [symbol] , a green heart emoji [symbol] , a yellow heart emoji [symbol] , a blue heart emoji [symbol] . In various implementations, a particular sibling emoji representation may function as both a canonical emoji representation and a sibling representation. For example, in this example scenario, the heart suit emoji [symbol] may function as the canonical emoji representation as well as one of the sibling emoji representations in the emoji genus.

In another example implementation, presume a dog emoji genus contains various different sibling dog emoji representations. Also, presume that the dog emoji genus has a dog face [symbol] as its canonical emoji representation, and consists of the following 5 sibling emoji representations: a dog face emoji a [symbol] , a white dog emoji [symbol] , a brown dog emoji [symbol] , a black dog on a leash emoji [symbol] , and a brown dog on a leash emoji [symbol] . As indicated herein, the dog face emoji [symbol] may represent both a sibling emoji representation and the canonical emoji representation.

In various implementations, the following emoji IDs red heart emoji, dog face emoji, red heart emoji [symbol] [symbol] [symbol] , red heart emoji, white dog emoji, red heart emoji [symbol] [symbol] [symbol] , pink heart emoji, brown dog emoji, blue heart emoji [symbol] [symbol] [symbol] , and heart suit emoji, brown dog emoji, heart suit emoji [symbol] [symbol] [symbol] are all valid representations of the emoji ID red heart emoji, dog face emoji, red heart emoji [symbol] [symbol] [symbol] , which includes the canonical emoji representation dog face emoji [symbol] . As shown, each emoji ID includes a sibling emoji representation. While these sibling emoji representations are different from each other, any of these emoji IDs represents the dog emoji genus as well as its canonical emoji representation dog face emoji [symbol] . As such, if a given spoofer attempted to one of these emoji IDs, each of these emoji IDs would point to or resolve to the same canonical emoji ID, thereby preventing spoofing.

In some implementations, the canonical emoji ID may be a textual representation of a canonical emoji representation. As such, in various implementations, the same canonical emoji ID may also function as a textual representation of one or more sibling emoji representations. In other words, the same canonical emoji ID corresponds to the emoji IDs of the sibling emoji representations (e.g., red heart [symbol] , a green heart [symbol] , a blue heart [symbol] , etc.).

In some implementations, when parsing a textual representation of a canonical emoji ID, the system may utilize the canonical short descriptors. As such, in some implementations, there may be exactly a 1:1 mapping of short descriptions to the canonical emoji ID. The mapping ratio may vary, depending on the particular implementation. When parsing an emoji string from a URL or API call, all potential emoji ID strings are first mapped to their canonical emoji representation to determine the canonical emoji ID.

Referring still to FIG. 2, at block 208, the system accesses a database using the canonical emoji string. Generally, as indicated above, an attacker may register a “fake” emoji ID that looks similar to the real emoji ID. The user clicks on the “fake” emoji ID thinking that it is the legitimate ID and gets spoofed. Conventionally, the user is lead to the wrong destination (e.g., lookup record, etc.).

Spoofing is prevented because anyone trying to represent the emoji ID red heart emoji, dog face emoji, red heart emoji [symbol] [symbol] [symbol] , using a similar looking set of emoji representations (e.g., red heart emoji, white dog emoji, red heart emoji [symbol] [symbol] [symbol] ) is thwarted, because this “fake” emoji ID points to or resolves to the same canonical emoji ID string (red heart emoji, dog face emoji, red heart emoji [symbol] [symbol] [symbol] ). As such, the system may access the database using the canonical emoji string. In particular, the system may access the database using the canonical emoji ID associated with the canonical emoji string.

The attacker cannot register the “fake” emoji ID, because the owner of the canonical emoji ID also simultaneously owns all similar-looking emoji IDs by virtue of the genus system, including the sibling emoji representations. Furthermore, the attacker cannot redirect potential victims to a different site or address, because the “fake” emoji ID resolves to the canonical emoji ID and consequently to the correct lookup records.

According to implementations disclosed herein, the user goes to the correct lookup record, because the all of the sibling emoji representations belong to the same genus canonical emoji representation. Each sibling of the sibling emoji representations function as the genus canonical emoji representation.

The following are additional example implementations. In various implementations, the preferred emoji representation and the canonical emoji representation are distinct emoji representations in a Unicode emoji set. Each of the sibling emoji representations are distinct emojis in the Unicode emoji set. In various implementations, sibling emoji representations and are selected by virtue of being clearly or potentially confused with the canonical emoji representation due to their similarities. In some implementations, the system may enable the user to select sibling emoji representations. In some implementations, the system may automatically without user intervention select one or more sibling emoji representations based on similarity. The system may use artificial intelligence and machine learning to generate one or more sibling emoji representations.

In an example scenario, a soccer ball emoji [symbol] has a Unicode code U+1F3C9 and an American football emoji [symbol] has code U+1F3C8. These emoji representations are completely different emojis, because their base Unicode codes are different. These are 2 completely different emojis, and are included in the same emoji genus. These emojis may be sibling emoji representations in the same emoji genus, because of the visual similarity between the two. As indicated here, the visual similarity may confuse the user who might not notice that they are different.

In various implementations, some emoji variations (e.g., skin tone, hair color, etc.) may have the same base Unicode code and therefore are not considered different emojis but variations on the base emoji. For example, the base Unicode code for a hand emoji with light skin would be the same as the base Unicode code for hand emoji with dark skin. Also, emoji variations due to skin tone, hair, or gender modifiers are also included in the emoji genus even though being technically different to siblings. In an example scenario, a thumbs up emoji [symbol] with light skin has a Unicode code U+1F44D. A thumbs up emoji [symbol] with dark skin has the same base Unicode code U+1F44D with a skin tone modifier U+1F3FD. The resulting Unicode code would be U+1F44D U+1F3FD. These two emoji representations may be included in an emoji genus due to their visual similarity, but they would not be considered or treated as different sibling emoji representations but mere variations.

In some implementations, the system may use solely canonical emoji IDs in database records. That is to say that a red heart emoji [symbol] , a heart suit emoji [symbol] , a pink heart emoji [symbol] , etc. returns the same data (e.g., from a resulting lookup, etc.) as a red heart emoji [symbol] , because they represent the same canonical emoji ID with a red heart emoji [symbol] .

In various implementations, the system enables emoji ID owners to choose to configure their preferred emoji ID representation from any choice of sibling emoji representations for each of the canonical emoji representations in their emoji ID. When taking an emoji ID as input into the system, the system first maps the emoji ID to its canonical form before applying any look ups. In general, the system enables the user to supply any emoji ID as input to a function that accepts an emoji ID, and the function will respond as if the canonical emoji ID was supplied. In various implementations, if a canonical emoji ID is specifically required as input for a given function, then the canonical emoji ID is explicitly stated.

In various implementations, system 102 may include a blockchain network (not shown) having nodes, where each node maintains respective copies of a blockchain. The blockchain network may include hundreds or thousands of nodes. Also, the blockchain network may be a distributed peer-to-peer network. In some implementations, the blockchain network may implement known consensus algorithms to validate transactions submitted to the blockchain network. A verified transaction may include transferred cryptocurrency, contracts, records, or other information to be recorded to the blockchain. In some implementations, multiple transactions are combined together into a block of data that is verified across a blockchain network. Once verified, this block of data can be added to an existing blockchain.

In various implementations, the blockchain includes a distributed ledger that maintains emoji identifications (IDs). As described in more detail herein, an emoji ID includes a sequence of emojis utilized to provide a user with an easy and intuitive way to identify a particular user or entity. In various implementations, the blockchain of the system may verify an emoji ID by checking the emoji ID against the base node of the blockchain to determine the authenticity or validity of the emoji ID. Further implementations directed to emoji IDs are described in more detail herein.

In various implementations, emoji IDs may be associated with public and private keys. Public and private keys are an integral component of cryptocurrencies and other digital assets such as non-fungible tokens (NFTs) built on blockchain networks and are part of a larger field of cryptography known as public-key cryptography (PKC) or asymmetric encryption. The goal of PKC is to easily transition from a first state (e.g., a private key) to a second state (e.g., a public key), while making reversing the transition from the second state to the first state nearly impossible, and in the process, proving possession of a secret key without exposing that secret key. The product is subsequently a one-way mathematical function, which makes it ideal for validating the authenticity of transactions such as cryptocurrency transactions because possession of the first state such as the secret key cannot be forged. PKC relies on a two-key model, the public and private key. The general purpose of PKC is to enable secure, private communication using digital signatures in a public channel that is susceptible to potentially malicious eavesdroppers.

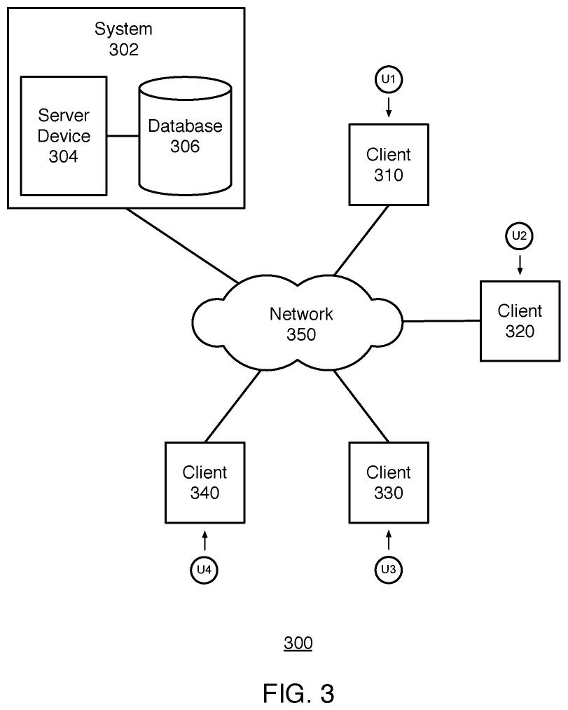

FIG. 3 is a block diagram of an example network environment 300, which may be used for some implementations described herein. In some implementations, network environment 300 includes a system 302, which includes a server device 304 and a database 306. For example, system 302 may be used to implement system 102 of FIG. 1, as well as to perform implementations described herein. Network environment 300 also includes client devices 310, 320, 330, and 340, which may communicate with system 302 and/or may communicate with each other directly or via system 302. Network environment 300 also includes a network 350 through which system 302 and client devices 310, 320, 330, and 340 communicate. Network 350 may be any suitable communication network such as a Wi-Fi network, Bluetooth network, the Internet, etc.

For ease of illustration, FIG. 3 shows one block for each of system 302, server device 304, and network database 306, and shows four blocks for client devices 310, 320, 330, and 340. Blocks 302, 304, and 306 may represent multiple systems, server devices, and network databases. Also, there may be any number of client devices. In other implementations, environment 300 may not have all of the components shown and/or may have other elements including other types of elements instead of, or in addition to, those shown herein.

While server 304 of system 302 performs implementations described herein, in other implementations, any suitable component or combination of components associated with server 302 or any suitable processor or processors associated with server 302 may facilitate performing the implementations described herein.

In the various implementations described herein, a processor of system 302 and/or a processor of any client device 310, 320, 330, and 340 cause the elements described herein (e.g., information, etc.) to be displayed in a user interface on one or more display screens.

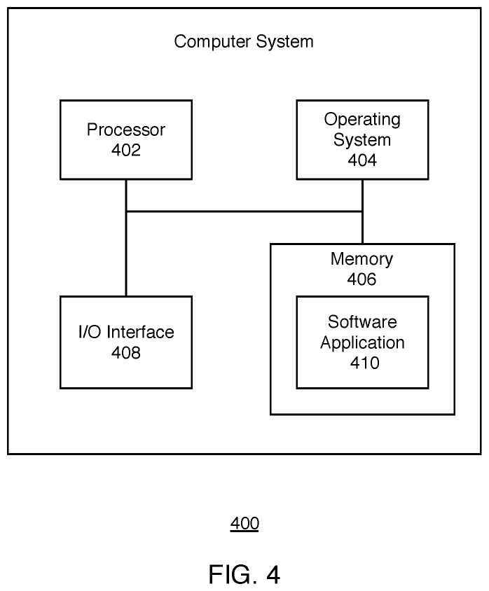

FIG. 4 is a block diagram of an example computer system 400, which may be used for implementations described herein. For example, computer system 400 may be used to implement server device 304 of FIG. 3 and/or system 102 of FIG. 1, as well as to perform implementations described herein. Computer system 400 is operationally coupled to one or more processing units such as processor 402, a memory 404, and a bus 406 that couples to various system components, including processor 402 and memory 404. Bus 406 represents one or more of any of several types of bus structures, including a memory bus, a memory controller, a peripheral bus, an accelerated graphics port, a processor or local bus using any of a variety of bus architectures, etc. Memory 404 may include computer readable media in the form of volatile memory, such as a random access memory (RAM) 408, a cache memory 410, and a storage unit 412, which may include non-volatile storage media or other types of memory. Memory 404 may include at least one program product having a set of at least one program code module such as program code 414 that are configured to carry out the functions of implementations described herein when executed by processor 402. Computer system 400 may also communicate with a display 416 or one or more other external devices 418 via input/output (I/O) interface(s) 420. Computer system 400 may also communicate with one or more networks via network adapter 422. In other implementations, computer system 400 may not have all of the components shown and/or may have other elements including other types of elements instead of, or in addition to, those shown herein.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various implementations of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising:
one or more processors; and
logic encoded in one or more non-transitory computer-readable storage media for execution by the one or more processors and when executed operable to cause the one or more processors to perform operations comprising:
receiving an emoji string, wherein the emoji string comprises a preferred emoji representation;
mapping the preferred emoji representation to a corresponding canonical emoji representation;
computing a canonical emoji ID based on the mapping, wherein the canonical emoji ID comprises a canonical emoji string, wherein the canonical emoji string comprises the canonical emoji representation; and
accessing a database using the canonical emoji string.

2. The system of claim 1, wherein the canonical emoji ID is associated with an emoji genus, and wherein the emoji genus is associated with the preferred emoji representation and one or more other sibling emoji representations.

3. The system of claim 1, wherein the canonical emoji ID is associated with an emoji genus, and wherein the emoji genus is associated with a group of sibling emoji representations having one or more shared characteristics.

4. The system of claim 1, wherein the preferred emoji representation is selectable from a plurality of sibling emoji representations.

5. The system of claim 1, wherein the preferred emoji representation functions as the canonical emoji representation.

6. The system of claim 1, wherein the canonical emoji ID is a textual representation of the canonical emoji representation.

7. The system of claim 1, wherein the preferred emoji representation and the canonical emoji representation are distinct emoji representations in a Unicode emoji set.

8. A computer-implemented method for preventing spoofing of emoji identifications, the method comprising:
receiving an emoji string, wherein the emoji string comprises a preferred emoji representation;
mapping the preferred emoji representation to a corresponding canonical emoji representation;
computing a canonical emoji ID based on the mapping, wherein the canonical emoji ID comprises a canonical emoji string, wherein the canonical emoji string comprises the canonical emoji representation; and
accessing a database using the canonical emoji string.

9. The method of claim 8, wherein the canonical emoji ID is associated with an emoji genus, and wherein the emoji genus is associated with the preferred emoji representation and one or more other sibling emoji representations.

10. The method of claim 8, wherein the canonical emoji ID is associated with an emoji genus, and wherein the emoji genus is associated with a group of sibling emoji representations having one or more shared characteristics.

11. The method of claim 8, wherein the preferred emoji representation is selectable from a plurality of sibling emoji representations.

12. The method of claim 8, wherein the preferred emoji representation functions as the canonical emoji representation.

13. The method of claim 8, wherein the canonical emoji ID is a textual representation of the canonical emoji representation.

14. The method of claim 8, wherein the preferred emoji representation and the canonical emoji representation are distinct emoji representations in a Unicode emoji set.

15. A non-transitory computer-readable storage medium with program instructions stored thereon, the program instructions when executed by one or more processors are operable to cause the one or more processors to perform operations comprising:
receiving an emoji string, wherein the emoji string comprises a preferred emoji representation;
mapping the preferred emoji representation to a corresponding canonical emoji representation;
computing a canonical emoji ID based on the mapping, wherein the canonical emoji ID comprises a canonical emoji string, wherein the canonical emoji string comprises the canonical emoji representation; and
accessing a database using the canonical emoji string.

16. The computer-readable storage medium of claim 8, wherein the canonical emoji ID is associated with an emoji genus, and wherein the emoji genus is associated with the preferred emoji representation and one or more other sibling emoji representations.

17. The computer-readable storage medium of claim 8, wherein the canonical emoji ID is associated with an emoji genus, and wherein the emoji genus is associated with a group of sibling emoji representations having one or more shared characteristics.

18. The computer-readable storage medium of claim 8, wherein the preferred emoji representation is selectable from a plurality of sibling emoji representations.

19. The computer-readable storage medium of claim 8, wherein the preferred emoji representation functions as the canonical emoji representation.

20. The computer-readable storage medium of claim 8, wherein the canonical emoji ID is a textual representation of the canonical emoji representation.
